(19) United States
(12) Patent Application Publication
(10) Pub. No.: US 2010/0073423 A1
(43) Pub. Date: Mar. 25, 2010

(54) LIQUID EJECTING APPARATUS

(75) Inventors: Satoshi NAKATA, Matsumoto-shi (JP); Hitoshi IGARASHI, Shiojiri-shi (JP); Yosuke NAKANO, Suwa-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/561,411

(22) Filed: Sep. 17, 2009

(30) Foreign Application Priority Data
Sep. 19, 2008 (JP) 2008-240394

(51) Int. Cl. B41J 2/165; B41J 23/02

(52) U.S. Cl. 347/34; 347/39

(57) ABSTRACT

A liquid ejecting apparatus includes a liquid ejecting head which ejects a liquid onto a liquid ejection surface of an ejection target member; a scanning unit which scans the liquid ejecting head relative to the ejection target member; a driving force transmission mechanism which transmits driving force of a rotary driving force source to the scanning unit through a belt; an encoder which detects a scanning position of the liquid ejecting head relative to the ejection target member and having a scale disposed at a position adjacent to the belt; and a neutralizing unit which removes static electricity from the belt.

### BACKGROUND

1. Technical Field

The present invention relates to a liquid ejecting apparatus which ejects a liquid onto a liquid ejection surface of an ejection target member.

Here, a liquid ejecting apparatus is not limited to an ink jet type recording apparatus, a copy machine, and a facsimile machine which eject ink onto an ejection target member such as a recording paper from a liquid ejecting head such as a recording head to perform recording for the recording paper, and is interpreted to include an apparatus which ejects a liquid, corresponding to a certain use instead of ink, onto an ejection target member from a liquid ejecting head and sticks a liquid to the ejection target member.

Examples of a liquid ejecting head include a color material ejecting head used for manufacturing a color filter of a liquid crystal display (LCD), an electrode material (conductive paste) ejecting head used for forming electrodes of an organic electroluminescence (EL) display or a plane emission display (FED), a bio-organic material ejecting head used for manufacturing a biochip, and a sample ejecting head which ejects a sample as a precise pipette as well as the recording head.

2. Related Art

An ink jet printer is well known as an example of a liquid ejecting apparatus which ejects a liquid onto a liquid ejection surface of an ejection target member. For example, a serial head type ink jet printer performs recording onto a recording surface of a recording paper such that an operation of ejecting ink (a liquid) from a recording head which reciprocates in a direction crossing a transport direction of a recording paper (an ejection target member) to form a dot on a recording surface (a liquid ejection surface) of the recording paper and an operation of transporting a predetermined transport amount of recording paper in the transport direction are alternately repeatedly performed. The ink jet printer aims to control the reciprocal operation of the recording head or the transport operation for the recording paper at the high accuracy and implement highly accurate recording. To this end, the ink jet printer generally includes a linear encoder for detecting the movement amount of the recording head or a rotary encoder for detecting the transport amount of the recording paper.

In the liquid ejecting apparatus, part of a liquid ejected onto the ejection target member from the liquid ejecting head may float in the liquid ejecting apparatus in the form of mist. For example, in the ink jet printer, part of ink ejected from the recording head is changed to ink mists, and ink mists float in an inner space of the printer. The ink mists stick to the recording paper to deteriorate the recording image quality. Further, when ink mists stick to a scale of the linear encoder or the rotary encoder, the scale reading accuracy of a scale sensor may deteriorate. That is, ink mists which stick to the scale of the encoder deteriorate the detection accuracy of the movement amount of the recording head or the transport amount for the recording paper, thereby deteriorating the recording accuracy.

In order to reduce the ink mists, as one example of a related art, an ink jet printer is known in which a charging member is installed at a location adjacent to an ink ejection area in which an ink is ejected from a recording head, and the charging member is electrically charged to a polarity different from the polarity of the ink mists to thereby attract and remove ink mists generated in the ink ejection area through electrostatic force (for example, JP-A-2006-335531 and 2006-335532).

However, in the related art described above, it is not easy to attract and remove ink mists which float in the inner space of the printer only through static electricity charged to the charging member.

In an ink jet printer with a driving force transmission mechanism using a belt as a component of a means for reciprocating the recording head in a direction crossing the transport direction of the recording paper or a means for transporting the recording paper in the transport direction, when the belt of the driving force transmission mechanism rotates, static electricity is generated due to contact charging or separation charging, and static electricity is charged to the belt. For this reason, in the ink jet printer, part of the ink mists which float in the inner space of the printer is attracted to the charged belt to the driving force transmission mechanism, and thus the ink mists are likely to stick to the scale of the encoder disposed at a location adjacent to the belt of the driving force transmission mechanism.

Further, when the belt of the driving force transmission mechanism is charged, the scale disposed at a location adjacent to the belt of the driving force transmission mechanism is inductively charged, and the charged scale attracts ink mists. In order to directly neutralize static electricity charged to the scale, a large neutralizing brush which comes in contact with the whole scale is needed, whereby the cost or size of the liquid ejecting apparatus greatly increases.

### SUMMARY

An advantage of some aspects of the invention is that it provides a liquid ejecting apparatus in which a phenomenon that mists of a liquid stick to the scale of the encoder is inhibited.

According to a first aspect of the invention, there is provided a liquid ejecting apparatus including: a liquid ejecting head which ejects a liquid onto a liquid ejection surface of an ejection target member; a scanning unit which scans the liquid ejecting head relative to the ejection target member; a driving force transmission mechanism which transmits driving force of a rotary driving force source to the scanning unit through a belt; an encoder which detects a scanning position of the liquid ejecting head relative to the ejection target member and having a scale disposed at a position adjacent to the belt; and a neutralizing unit which removes static electricity of the belt.

According to this feature, since static electricity charged to the belt due to contact charging or separation charging generated when the belt of the driving force transmission mechanism rotate can be removed, it is possible to prevent mists of a liquid from being attracted to the belt. Therefore, the possibility that mists of a liquid will stick to the scale disposed at a location adjacent to the belt can be reduced. Since static electricity of the belt is removed, induction charging of the scale is inhibited, whereby the possibility that the scale will be charged to attract mists of a liquid can be reduced.

According to the liquid ejecting apparatus of the first aspect, the liquid ejecting apparatus having the encoder can have an effect of reducing the possibility that mists of a liquid will stick to the scale of the encoder.

Since charging of the scale is inhibited without installing a large neutralizing brush which comes in contact with the whole scale, the cost or size of the liquid ejecting apparatus does not greatly increase, and the possibility that ink mists will stick to the scale of the encoder can be reduced.

According to a second aspect of the invention, in the liquid ejecting apparatus of the first aspect, the belt is engaged between a driving pulley and a driven pulley, and the neutralizing unit has a neutralizer which neutralizes the belt at a position adjacent to the driven pulley.

Contact charging or separation charging generated when the belt of the driving force transmission mechanism is generated at a location in which the driving pulley or the driven pulley and the belt come in contact with each other and are separated from each other. Since the driving pulley is generally made of a conductive material, it is possible to make static electricity generated at the driving pulley side escape to the case frame through the motor case from the rotation shaft of a rotary driving force source such as a motor. On the other hand, the driven pulley aims to reduce the manufacturing cost and minimize the inertia moment to reduce the rotation load and so is generally made of an insulating material such as plastic. Therefore, static electricity generated at the driven pulley side made of an insulating material such as plastic has no place to escape, and thus the belt of the driving force transmission mechanism is likely to be charged.

According to the invention, a neutralizer for neutralizing the belt at a location adjacent to the driven pulley is preferably disposed as a neutralizing unit for the belt of the driving force transmission mechanism. Therefore, static electricity charged to the belt of the driving force transmission mechanism can be further effectively removed.

According to a third aspect of the invention, in the liquid ejecting apparatus of the second aspect, the neutralizer neutralizes the belt at a location in which the belt is separated from the driven pulley.

It is determined that most of static electricity generated when the belt of the driving force transmission mechanism rotates is generated due to separation charging generated at a location in which the belt is separated from the driven pulley. According to the invention, the belt is preferably neutralized at a location in which the belt is separated from the driven pulley. Therefore, static electricity charged to the belt of the driving force transmission mechanism can be further effectively removed.

According to a fourth aspect of the invention, in the liquid ejecting apparatus of the third aspect, the neutralizing unit includes a first neutralizer which neutralizes the belt at a location in which the belt is separated from the driven pulley when the belt rotates in a forward rotation direction and a second neutralizer which neutralizes the belt at a location in which the belt is separated from the driven pulley when the belt rotates in a reverse rotation direction.

According to this feature, in the liquid ejecting apparatus having a mechanism which alternately repeatedly performs a forward rotation and a reverse rotation of the belt such as a mechanism which reciprocates the liquid ejecting head, static electricity charged to the belt of the driving force transmission mechanism can be further effectively removed.

According to a fifth aspect of the invention, in the liquid ejecting apparatus of the second to fourth aspects, the neutralizer includes a brush-like member which is made of conductive fiber and is grounded.

When the self-discharge type neutralizer having the configuration is employed, the liquid ejecting apparatus of the invention can be implemented with an extremely low cost configuration.

Here, “grounding” is broadly interpreted to include not only being electrically connected to the ground but also case-grounding in which the case frame of the liquid ejecting apparatus is electrically connected as well as grounding via being electrically connected to a reference potential terminal of an electronic circuit.

According to a sixth aspect of the invention, there is provided a liquid ejecting apparatus including: a liquid ejecting head which ejects a liquid onto a liquid ejection surface of an ejection target member; a scanning unit which scans the liquid ejecting head relative to the ejection target member; a driving force transmission mechanism which transmits driving force of a rotary driving force source to the scanning unit through a belt; and an encoder which detects a scanning position of the liquid ejecting head relative to an ejection target member and having a scale disposed at a position adjacent to the belt, wherein the belt is engaged between a driving pulley and a driven pulley, and the driven pulley is made of a conductive material and is grounded.

According to this feature, for example, it is possible to make static electricity generated at the driven pulley side escape to the case frame through a support shaft of the driven pulley. Therefore, static electricity charged to the belt can be reduced. Further, it is possible to prevent the scale of the encoder from being charged due to induction charging from the belt. Therefore, the liquid ejecting apparatus having the encoder can have an effect of reducing the possibility that mists of a liquid will stick to the scale of the encoder.

### BRIEF DESCRIPTION OF THE DRAWINGS

The invention will be described with reference to the accompanying drawings, wherein like numbers reference like elements.

FIG. 1 is a main part perspective view of an ink jet printer.

FIG. 2 is a main part side view of an ink jet printer.

FIG. 3 is a perspective view illustrating an enlarged part of an ink jet printer (a first embodiment).

FIG. 4 is a perspective view illustrating an enlarged part of an ink jet printer (a second embodiment).

FIG. 5 is a perspective view illustrating an enlarged part of an ink jet printer (a third embodiment).

### DESCRIPTION OF EXEMPLARY EMBODIMENTS

Hereinafter, embodiments of the present invention will be described with reference to the accompanying drawings.

### Schematic Configuration of an Ink Jet Printer

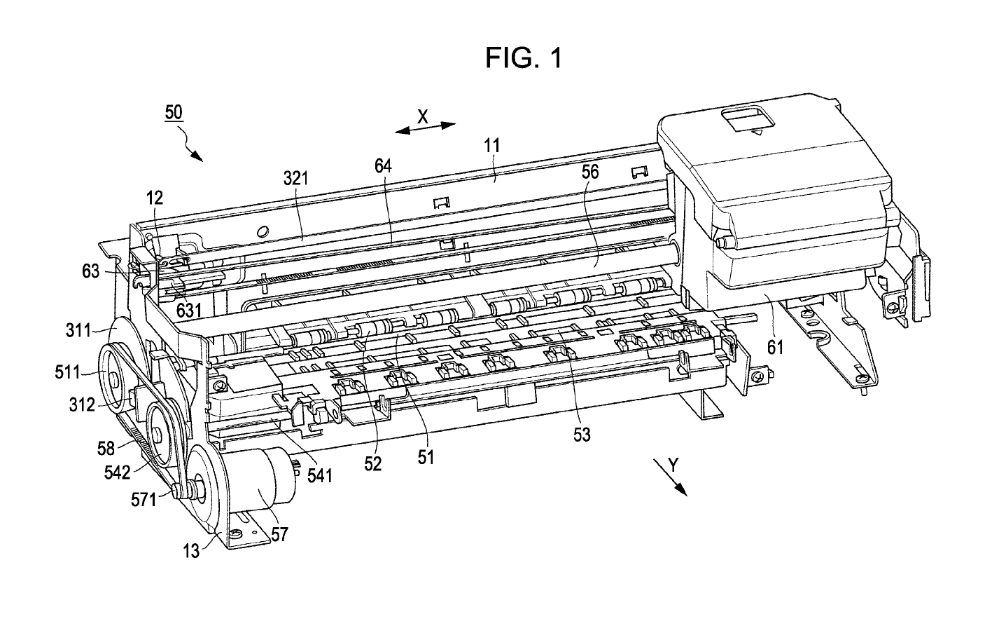

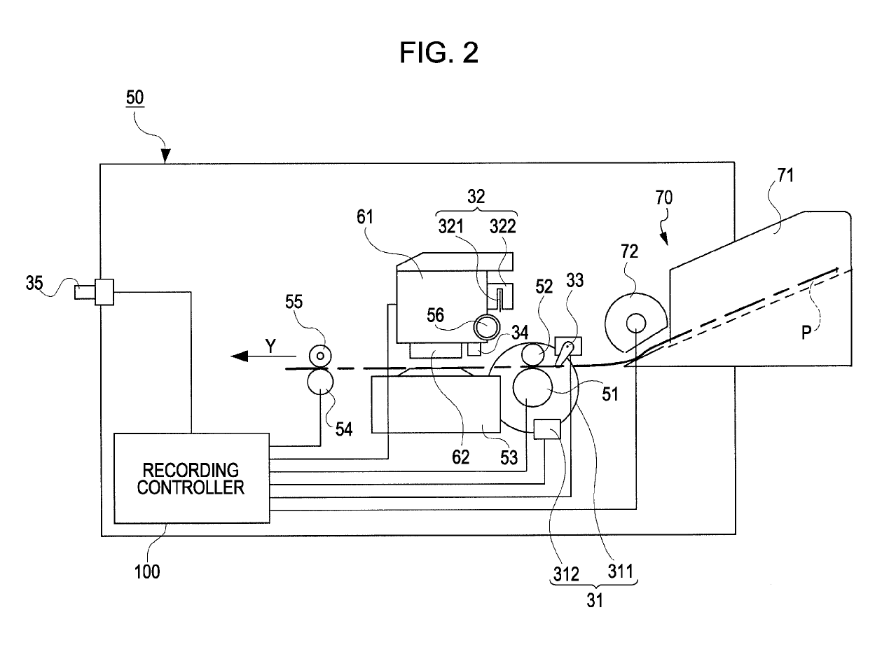

First, a schematic configuration of an ink jet printer 50 as a “liquid ejecting apparatus” according to the invention will be described with reference to FIGS. 1 and 2.

FIG. 1 is a main part perspective view illustrating an ink jet printer 50, and FIG. 2 is a main part side view illustrating the ink jet printer 50.

The ink jet printer 50 according to the invention includes an automatic feeding apparatus 70 for feeding a recording paper P as an “ejection target member” into the ink jet printer 50. The ink jet printer 50 includes a recording head 62 as a “liquid ejecting head” which ejects ink as a “liquid” onto a recording surface (a liquid ejection surface) of the recording paper P supported by a platen 53 and performs recording. The ink jet printer 50 includes a transport driving roller 51, a transport driven roller 52, a discharge driving roller 54, and a discharge driven roller 55 which configure a “scanning unit” which scans the recording head 62 relative to the recording paper P in a sub-scanning direction Y.

The automatic feeding apparatus 70 includes a feeding tray 71 and a feeding roller 72. The feeding tray 71 is mounted and accommodated in a state in which a plurality of recording papers P is stacked. The feeding roller 72 rotates due to the rotary driving force of a feeding motor which is not illustrated in the drawings. In the recording papers P stacked on the feeding tray 71, the recording paper P at the highest position contacts an outer peripheral surface of the feeding roller 72 and is fed to a location in which a front end thereof arrives at a part which the transport driving roller 51 and the transport driven roller 52 contact, by the rotation of the feeding roller 72.

The transport driving roller 51 has a high friction coating film installed on a surface thereof and is supplied with rotary driving force of the transport motor 57 in order to rotate. The transport driven roller 52 is driven while rotatably journaled and comes in contact with an outer peripheral surface of the transport driving roller 51 due to the urging force of an urging means such as a spring which is not illustrated in the drawings. The recording paper P fed by the automatic feeding apparatus 70 is sandwiched between the transport driving roller 51 and the transport driven roller 52 and transported in the sub-scanning direction Y on the platen 53 by the driving rotation of the transport driving roller 51.

The recording head 62 is disposed at a bottom of the carriage 61 as a “scanning means” which scans the recording head 62 in a main-scanning direction X (a direction crossing the sub-scanning direction Y) relative to the recording paper P on the platen 53. A plurality of ejecting nozzles for ejecting ink is disposed on a head surface of the recording head 62. The carriage 61 is supported by a carriage guide shaft 56 to be able to reciprocate in the main-scanning direction X while maintaining a state in which the head surface of the recording head 62 and the recording surface of the recording paper P on the platen 53 are approximately parallel to each other.

On a feeding path between the feeding roller 72 and the transport driving roller 51, a paper detector 33 which detects a front end position and a rear end position of the recording paper P in the sub-scanning direction Y is disposed. A PW sensor 34 which detects both end positions of the recording paper P in the main-scanning direction X is disposed at a bottom of the carriage 61. A power switch 35 is a switch for performing a power ON/OFF operation of the ink jet printer 50. Output signals of the paper detector 33, the PW sensor 34, and the power switch 35 are input to a recording controller 100.

Recording for the recording paper P on the platen 53 is performed such that an operation in which the carriage 61 reciprocates in the main-scanning direction X and ink is ejected from the head surface of the recording head 62 onto the recording surface to form a dot and an operation in which a predetermined amount of the recording papers P are transported in the sub-scanning direction Y by the driving rotation of the transport driving roller 51 are alternately repeatedly performed. After ink is ejected, the recording paper P is sandwiched between the discharge driving roller 54 and the discharging driven roller 55, and fed and discharged in the sub-scanning direction Y by the driving rotation of the discharge driving roller 54. Such recording control is performed by the recording controller 100 as a “controller” having a microcomputer control circuit.

### Driving Mechanism of the Carriage 61

Next, a mechanism which reciprocates the carriage 61 in the main-scanning direction X will be described with reference to FIGS. 1 and 2.

A carriage belt 64 is engaged between a driving pulley (not illustrated) and a driven pulley 63 which are disposed on a rotation shaft of a carriage driving motor (not illustrated). The carriage belt 64 is an endless belt made of, for example, urethane. A part of the carriage belt 64 is connected to the carriage 61. The driven pulley 63 is rotatably journaled through a driven pulley holder 631. The carriage 61 reciprocates in the main-scanning direction X when the carriage driving motor rotates so that the carriage belt 64 rotates in both directions (a driving force transmission mechanism).

The ink jet printer 50 includes a linear encoder 32 which detects the main-scanning position of the recording head 62 relative to the recording paper P. The linear encoder 32 includes a linear scale 321 and a linear scale sensor 322. The linear scale 321 is a scale member of a tape form and has a plurality of slits which are formed at a predetermined regular interval. The linear scale 321 is disposed approximately parallel to a reciprocating direction (the main-scanning direction X) of the carriage 61 at a position adjacent to the carriage belt 64 as illustrated in FIG. 1. The linear scale 321 is mounted between side frames 13 of a case frame 11 of the ink jet printer 50 through a coil spring 12. The linear scale sensor 322 is a sensor which can detect a slit of the linear scale 321 and mounted on the carriage 61. An output signal of the linear scale sensor 322 is input to the recording controller 100.

### Driving Mechanism of the Transport Driving Roller 51 and the Discharge Driving Roller 54

Next, a mechanism which rotates the transport driving roller 51 and the discharge driving roller 54 to transport the recording paper P in the sub-scanning direction Y will be described below with reference to FIGS. 1 and 2.

A gear wheel 511 is disposed on an end of the transport driving roller 51. A gear wheel 542 is disposed on an end of the rotation shaft 541 of the discharge driving roller 54. A paper transport belt 58 is engaged with a driving pulley 571 of the transport motor 57, the gear wheel 511 and the gear wheel 542. The paper transport belt 58 is an endless belt made of, for example, urethane. Rotary driving force of the transport motor 57 is transferred to the gear wheel 511 and the gear wheel 542 through the paper transport belt 58, so that the transport driving roller 51 and the discharge driving roller 54 rotate.

The ink jet printer 50 includes a rotary encoder 31 which detects a sub-scanning position of the recording head 62 relative to the recording paper P. The rotary encoder 31 includes a rotary scale 311 and a rotary scale sensor 312. The rotary scale 311 is a scale member of a disk form and has a plurality of slits which are formed on a concentric circle at a regular interval. The rotary scale 311 is installed to be integrated with the gear wheel 511 and disposed at a location adjacent to the paper transport belt 58 as illustrated in FIG. 1. The rotary scale sensor 312 is a sensor which can detect a slit of the rotary scale 311 and is disposed at a location adjacent to the rotary scale 311. An output signal of the rotary scale sensor 312 is input to the recording controller 100.

### First Embodiment

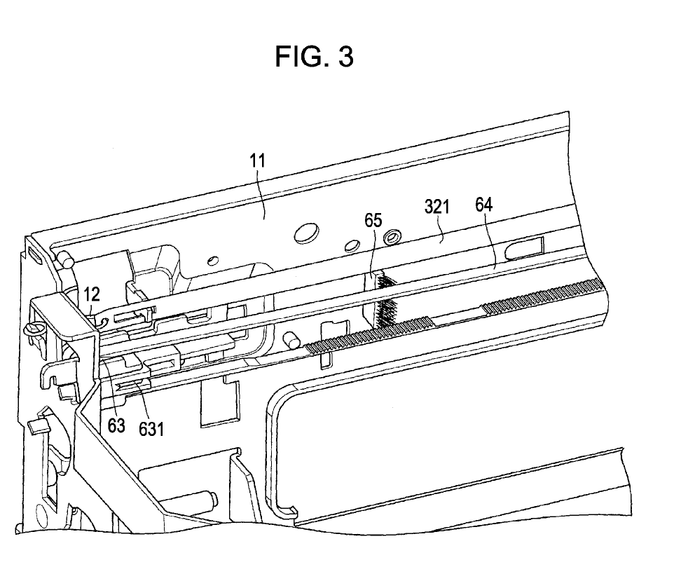

A first embodiment of the invention will be described with reference to FIG. 3.

FIG. 3 illustrates an ink jet printer 50 according to the first embodiment of the invention and is a perspective view illustrating an enlarged part of the ink jet printer 50.

The ink jet printer 50 according to the first embodiment includes a neutralizing unit which removes static electricity from the carriage belt 64. In further detail, the ink jet printer 50 according to the first embodiment includes a neutralizer 65 which neutralizes the carriage belt 64 at a location adjacent to the driven pulley 63.

The neutralizer 65 is a member having a brush-like part made of conductive fiber and is disposed to be electrically connected to the case frame 11 and case-grounded. The neutralizer 65 is disposed such that a front end of the brush-like part slidingly contacts the side of the carriage belt 64 or faces the side of the carriage belt 64 with a very small gap therebetween so that static electricity can be removed by corona discharging between the front end of the brush-like part and the side of the carriage belt 64. That is, the neutralizer 65 is generally called a neutralizing brush and is known as a self-discharge type neutralizer.

Since the neutralizing unit for removing static electricity of the carriage belt 64 is disposed as described above, static electricity charged to the carriage belt 64 can be removed. Therefore, since it is possible to prevent ink mists from being attracted to the charged carriage belt 64, the possibility that ink mists will stick to the linear scale 321 disposed at a location adjacent to the carriage belt 64 can be reduced. Since static electricity of the carriage belt 64 is removed, induction charging of the linear scale 321 is inhibited, whereby the possibility that the linear scale 321 will be charged to attract ink mists is reduced.

Therefore, according to the ink jet printer 50 of the first embodiment, the possibility that ink mists will stick to the linear scale 321 disposed at a location adjacent to the carriage belt 64 can be reduced. Since charging of the linear scale 321 is inhibited without installing a large neutralizing brush which comes in contact with the whole linear scale 321, the cost or size of the ink jet printer 50 does not greatly increase, and the possibility that ink mists will stick to the linear scale 321 can be reduced. Further, the possibility that paper powder will stick to the linear scale 321 can be reduced. Furthermore, since the possibility that ink mists will stick to the carriage guide shaft 56 disposed at a location adjacent to the carriage belt 64 can be reduced, the possibility that the driving load of the carriage 61 will increase due to ink mists can be reduced.

The driven pulley 63 is generally made of an insulating material such as plastic. In this case, since static electricity generated at the driven pulley 63 side has no place to escape, the carriage belt 64 is more likely to be charged. In this case, according to the present embodiment, the neutralizer 65 is preferably disposed at a location adjacent to the driven pulley 63 to neutralize the carriage belt 64. Therefore, static electricity charged to the carriage belt 64 can be further effectively removed. Further, when a driving pulley (not illustrated) is made of an insulating material such as plastic, a neutralizer 65 is preferably further disposed at a location adjacent to the driving pulley to neutralize the carriage belt 64.

### Second Embodiment

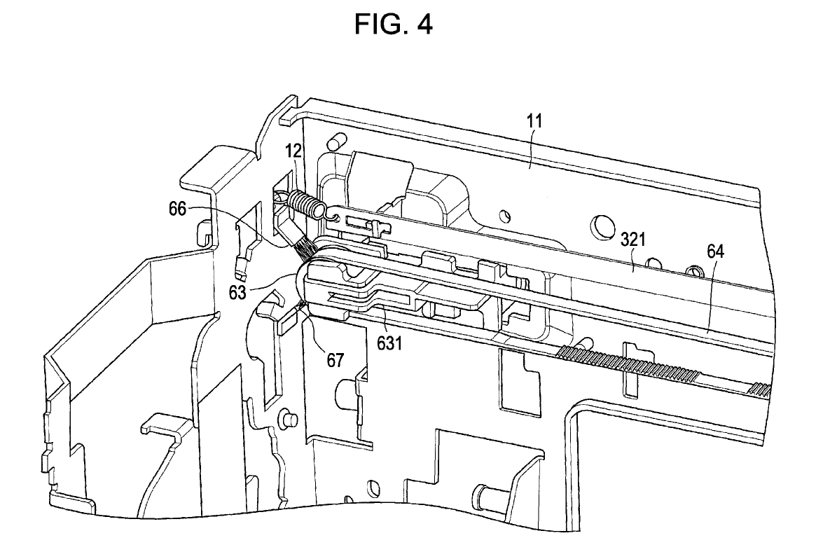

A second embodiment of the invention will be described with reference to FIG. 4.

FIG. 4 illustrates an ink jet printer 50 according to the second embodiment of the invention and is a perspective view illustrating an enlarged part of the ink jet printer 50.

The ink jet printer 50 according to the second embodiment includes a first neutralizer 66 and a second neutralizer 67 which are disposed at locations in which the carriage belt 64 is separated from the driven pulley 63 to neutralize the carriage belt 64. The first neutralizer 66 and the second neutralizer 67 are neutralizing units which have the same configuration as the neutralizer 65 of the first embodiment. Since it is determined that most of the static electricity generated when the carriage belt 64 rotates is generated due to separation charging at a location in which the carriage belt 64 is separated from the driven pulley 63, the static electricity of the carriage belt 64 at that location is neutralized, whereby static electricity charged to the carriage belt 64 can be further effectively removed.

The first neutralizer 66 is disposed at a location in which the carriage belt 64 is separated from the driven pulley 63 to neutralize the carriage belt 64 when the carriage belt 64 rotates in a forward direction as illustrated in FIG. 4. On the other hand, the second neutralizer 67 is disposed at a location in which the carriage belt 64 is separated from the driven pulley 63 to neutralize the carriage belt 64 when the carriage belt 64 rotates in a reverse direction as illustrated in FIG. 4. As described above, it is preferable to dispose the first neutralizer 66 at a location corresponding to separation charging at the time of forward rotation and dispose the second neutralizer 67 at a location corresponding to separation charging at the time of reverse rotation. Therefore, static electricity charged to the carriage belt 64 which rotates in both directions can be further effectively removed.

### Third Embodiment

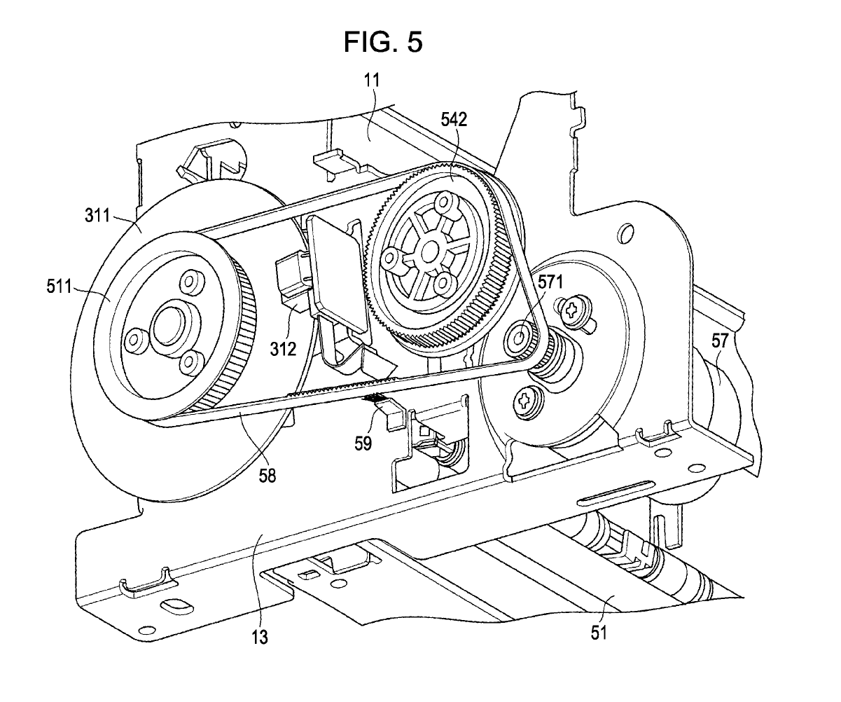

A third embodiment of the invention will be described with reference to FIG. 5.

FIG. 5 illustrates an ink jet printer 50 according to the third embodiment of the invention and is a perspective view illustrating an enlarged part of the ink jet printer 50.

The ink jet printer 50 according to the third embodiment includes a neutralizing unit which removes static electricity of the paper transport belt 58. In further detail, the ink jet printer 50 according to the third embodiment includes a neutralizer 59 which neutralizes the paper transport belt 58. The neutralizer 59 is a neutralizing unit which has the same configuration as the neutralizer 65 of the first embodiment.

As described above, the neutralizing unit for removing the static electricity of the paper transport belt 58 is disposed to remove static electricity charged to the paper transport belt 58. Therefore, since it is possible to prevent ink mists from being attracted to the charged paper transport belt 58, the possibility that ink mists will stick to the rotary scale 311 disposed at a location adjacent to the paper transport belt 58 can be reduced. Since static electricity of the paper transport belt 58 is removed, induction charging of the rotary scale 311 can be inhibited, whereby the possibility that the rotary scale 311 will be charged to attract ink mists can be reduced.

According to the ink jet printer 50 of the third embodiment, the possibility that ink mists will stick to the rotary scale 311 disposed at a location adjacent to the paper transport belt 58 can be reduced. Since charging of the rotary scale 311 is inhibited without installing a large neutralizing brush which comes in contact with the whole rotary scale 311, the cost or size of the ink jet printer 50 does not greatly increase, and the possibility that ink mists will stick to the rotary scale 311 can be reduced.

### Other Embodiments

As another embodiment of the invention, instead of the neutralizers 59, 65, 66, and 67 which are the self-discharge type neutralizers in the first to third embodiments, voltage application type neutralizers which are well-known may be installed.

As still another embodiment of the invention, the driven pulley 63 of the carriage belt 64 may be made of a conductive material and case-grounded to the case frame 11 through a support shaft of the driven pulley 63. Therefore, static electricity charged to the carriage belt 64 escapes to the case frame 11 and is removed. The driven pulley 63 may be made of a conductive material such as aluminum or sintered alloy.

Further, when the paper transport belt 58 or the carriage belt 64 is made of an insulating material such as urethane, a conductive material such as a carbon material may be mixed therein. In this case, charging of the paper transport belt 58 or the carriage belt 64 can be further inhibited.

However, the invention is not limited to the embodiments described above, and it would be understood that various modification can be made within the scope of the invention as defined in the claims and included within the scope of the invention.

What is claimed is:

1. A liquid ejecting apparatus, comprising:
a liquid ejecting head which ejects a liquid onto a liquid ejection surface of an ejection target member;
a scanning unit which scans the liquid ejecting head relative to the ejection target member;
a driving force transmission mechanism which transmits driving force of a rotary driving force source to the scanning unit through a belt;
an encoder which detects a scanning position of the liquid ejecting head relative to the ejection target member and having a scale disposed at a position adjacent to the belt; and
a neutralizing unit which removes static electricity from the belt.

2. The liquid ejecting apparatus according to claim 1,
wherein the belt is engaged between a driving pulley and a driven pulley, and the neutralizing unit has a neutralizer which neutralizes the belt at a position adjacent to the driven pulley.

3. The liquid ejecting apparatus according to claim 2,
wherein the neutralizer neutralizes the belt at a location in which the belt is separated from the driven pulley.

4. The liquid ejecting apparatus according to claim 3,
wherein the neutralizing unit includes a first neutralizer which neutralizes the belt at a location in which the belt is separated from the driven pulley when the belt rotates in a forward rotation direction and a second neutralizer which neutralizes the belt at a location in which the belt is separated from the driven pulley when the belt rotates in a reverse rotation direction.

5. The liquid ejecting apparatus according to claim 2,
wherein the neutralizer includes a brush-like member which is made of conductive fiber and is grounded.

6. A liquid ejecting apparatus, comprising:
a liquid ejecting head which ejects a liquid onto a liquid ejection surface of an ejection target member;
a scanning unit which scans the liquid ejecting head relative to the ejection target member;
a driving force transmission mechanism which transmits driving force of a rotary driving force source to the scanning unit through a belt; and
an encoder which detects a scanning position of the liquid ejecting head relative to an ejection target member and having a scale disposed at a position adjacent to the belt,
wherein the belt is engaged between a driving pulley and a driven pulley, and the driven pulley is made of a conductive material and is grounded.
